(19) United States
(12) Patent Application Publication
(10) Pub. No.: US 2012/0133572 A1
(43) Pub. Date: May 31, 2012

(54) ANTENNA

(75) Inventors: CHO-KANG HSU, Tu-Cheng (TW); CHIA-HUNG SU, Tu-Cheng (TW)

(73) Assignee: CHI MEI COMMUNICATION SYSTEMS, INC., Tu-Cheng (TW)

(21) Appl. No.: 13/052,204

(22) Filed: Mar. 21, 2011

(30) Foreign Application Priority Data
Nov. 26, 2010 (TW) 99140983

(51) Int. Cl. H01Q 21/00

(52) U.S. Cl. 343/893

(57) ABSTRACT

An antenna is used in an electronic device. The electronic device includes a circuit board. The antenna includes a first antenna portion, a second antenna portion, a first feed portion, and a second feed portion. The first antenna portion is longer than the second antenna portion. The first antenna portion and the second antenna portion are perpendicularly disposed around the circuit board and in one exemplary embodiment may be spaced from the perimeter edge of the circuit board.

### BACKGROUND

1. Technical Field

The present disclosure relates to an antenna used in an electronic device.

2. Description of Related Art

Electronic devices such as mobile phones, personal digital assistants, and laptop computers are widely used. Antennas are installed in such electronic devices to receive/send wireless signals. Many devices may operate at different frequencies (e.g., DCS1800, PCS1900, UMTS2100), requiring that the antennas be multiband antennas.

However, structures of many multiband antennas are complicated, such that the size of these antennas cannot be reduced.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding portions throughout the figures.

FIG. 1 is a perspective view of an exemplary embodiment of an electronic device including an antenna.

FIG. 2 is a return loss diagram of a first antenna portion of FIG. 1.

FIG. 3 is a return loss diagram of a second antenna portion of FIG. 1.

FIG. 4 is a perspective view of another exemplary embodiment of an electronic device including an antenna.

### DETAILED DESCRIPTION

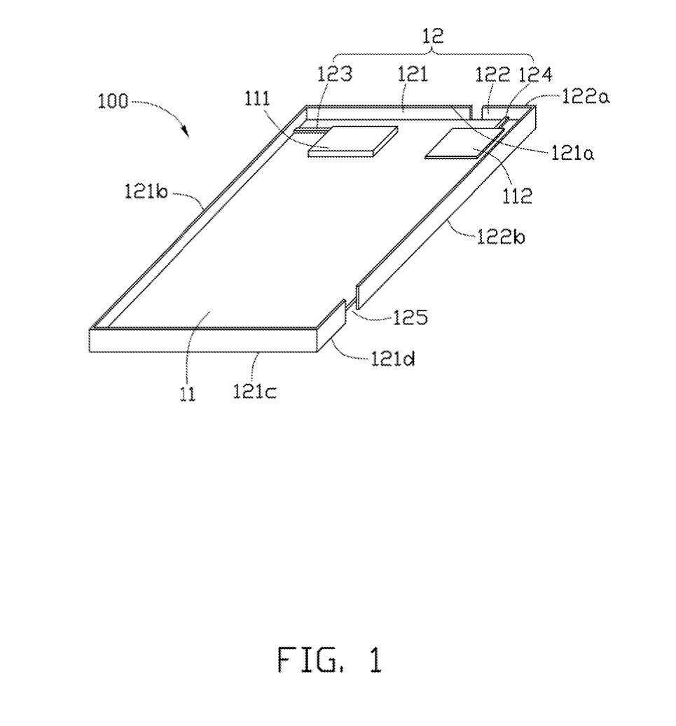

FIG. 1 is a perspective view of an exemplary embodiment of an electronic device 100 including an antenna 12. The electronic device 100 may be a mobile phone, a personal digital assistant, or a laptop computer, for example. In the exemplary embodiment, the electronic device is a mobile phone. The antenna 12 is used to receive/send wireless signals. The electronic device 100 further includes a circuit board 11. The circuit board 11 includes a first chip 111 and a second chip 112. The first chip 111 is used to process GSM, EGSM, DCS, PCS, and WCDMA signals. The second chip 112 is used to process GPS and BLUETOOTH signals.

The antenna 12 includes a first antenna portion 121, a second antenna portion 122, a first feed portion 123, and a second feed portion 124. The first antenna portion 121 and the second antenna portion 122 are perpendicularly disposed around the circuit board 11. The first antenna portion 121 is operative for GSM, EGSM, DCS, PCS, and WCDMA signals. The second antenna portion 122 is operative for GPS and BLUETOOTH signals. In the exemplary embodiment, the first antenna portion 121 and the second antenna portion 122 are bent sheets made of metal or flexible printed circuits.

The first antenna portion 121 is formed by antenna segments 121a, 121b, 121c, and 121d. The second antenna portion 122 is formed by antenna segments 122a and 122b. The length of the first antenna portion 121 (i.e, the combined length of the antenna segments 121a, 121b, 121c, and 121d) is longer than the length of the second antenna portion 122 (i.e., the combined length of the antenna segments 122a and 122b). The first antenna portion 121 and the second antenna portion 122, through their respective antenna segments, are perpendicularly disposed around the circuit board 11. The first antenna portion 121 and the second antenna portion 122 jointly form a generally loop-like structure. A gap 125 is defined between the first antenna portion 121 and the second antenna portion 122. The first feed portion 123 connects to the first antenna portion 121 and the first chip 111. The second feed portion 124 connects to the second antenna portion 122 and the second chip 112.

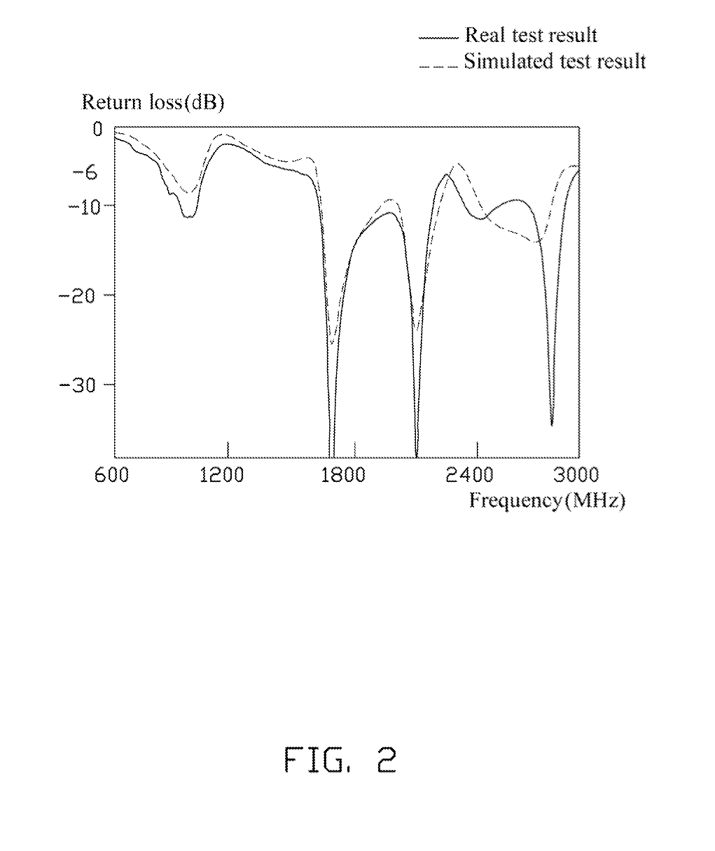

FIG. 2 is a return loss diagram of the first antenna portion 121 of FIG. 1. The return loss values of the first antenna portion 121 are less than −6 dB at frequencies of 824 MHz, 960 MHz, 1710 MHz, and 2170 MHz, such that the antenna 12 may operate according to GSM850, EGSM900, DCS1800, PCS1900, and WCDMA2100 communication standards.

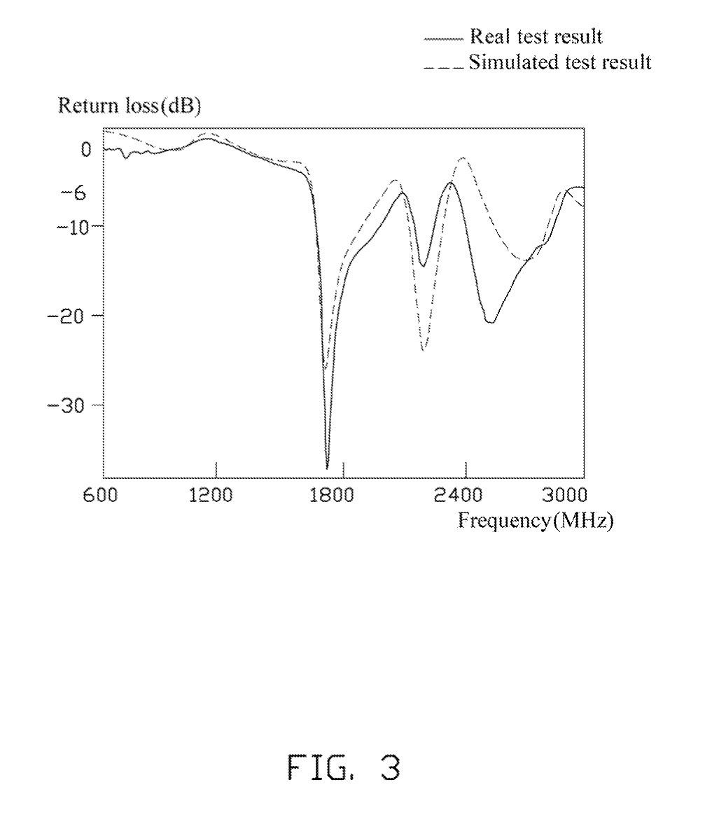

FIG. 3 is a return loss diagram of the second antenna portion 122 of FIG. 1. The return loss values of the second antenna portion 122 are less than −6 dB at frequencies of 1575 MHz, and 2400 MHz, such that the antenna 12 may operate at GPS and BLUETOOTH frequencies.

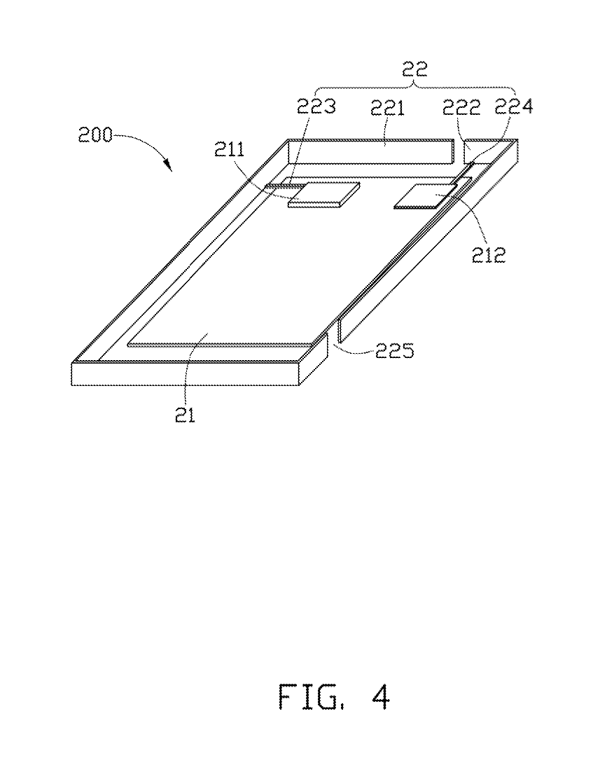

FIG. 4 is a perspective view of another exemplary embodiment of an electronic device 200 including an antenna 22. The electronic device 200 further includes a circuit board 21. The circuit board 21 includes a first chip 211 and a second chip 212. The antenna 22 includes a first antenna portion 221, a second antenna portion 222, a first feed portion 223, and a second feed portion 224. In this exemplary embodiment, the first antenna portion 221 and the second antenna portion 222 are bent sheets made of metal or flexible printed circuits. The first feed portion 223 connects to the first antenna portion 221 and the first chip 211. The second feed portion 224 connects to the second antenna portion 222 and the second chip 212.

The first antenna portion 221 is longer than the second antenna portion 222. The first antenna portion 221 and the second antenna portion 222 are perpendicularly disposed around the circuit board 21. In this exemplary embodiment, the first antenna portion 221 and the second antenna portion 222 are spaced from a perimeter edge of circuit board 21. The first antenna portion 221 and the second antenna portion 222 jointly form a generally loop-like structure. A gap 225 is defined between the first antenna portion 121 and the second antenna portion 122.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of portions within the principles of the present invention to the full extent indicated by the broad general meaning of the terms in which the appended claims are expressed.

What is claimed is:

1. An antenna used in an electronic device, the electronic device comprising a circuit board, the antenna comprising:
a first antenna portion; and
a second antenna portion;
wherein the first antenna portion and the second antenna portion are perpendicularly disposed around the circuit board; and
wherein the first antenna portion is longer than the second antenna portion.

2. The antenna of claim 1, wherein the first antenna portion and the second antenna portion each comprise a plurality of antenna segments and the antenna segments are perpendicularly disposed around the circuit board.

3. The antenna of claim 1, wherein the circuit board comprises a first chip.

4. The antenna of claim 3, further comprises a first feed portion connecting to the first antenna portion and the first chip.

5. The antenna of claim 1, the circuit board comprises a second chip.

6. The antenna of claim 5, further comprises a second feed portion connecting to the second antenna portion and the second chip.

7. The antenna of claim 1, wherein the circuit board has a perimeter edge and the first antenna portion and the second antenna portion are spaced from the perimeter edge of the circuit board.
